(19) United States
(12) Patent Application Publication
(10) Pub. No.: US 2009/0323358 A1
(43) Pub. Date: Dec. 31, 2009

(54) TRACK LIGHTING SYSTEM HAVING HEAT SINK FOR SOLID STATE TRACK LIGHTS

(76) Inventor: Keith Scott, Los Gatos, CA (US)

Correspondence Address: Haynes and Boone, LLP;IP Section, 2323 Victory Avenue, SUITE 700, Dallas, TX, 75219, US

(21) Appl. No.: 12/165,544

(22) Filed: Jun. 30, 2008

(51) Int. Cl. F21V 29/00

(52) U.S. Cl. 362/373

(57) ABSTRACT

Embodiments of the current invention seek to increase heat dissipation by utilizing a track lighting system with a heat sink, thus accomplishing increased heat dissipation via a separate, easily-attached device, i.e. a heat sinking track, rather than altering the solid state light itself. Other embodiments seek to enhance transmission of heat from the solid-state light source to the heat sink track. In this manner, embodiments of the invention increase the amount of heat dissipated from solid state lights.

### BRIEF DESCRIPTION OF THE INVENTION

This invention relates generally to solid state lights. More specifically, this invention relates to heat sink apparatuses for solid state track lights.

### BACKGROUND OF THE INVENTION

The operational power of many current solid state lights, such as light-emitting diode (LED) lights, is often limited by the lights' ability to dissipate heat. More particularly, increasing the current of a solid state light increases the amount of heat generated. Beyond a certain point, this excess heat becomes detrimental to the performance of the solid state lighting system, resulting in reduced performance and/or operational life. Accordingly, increasing the ability of a solid state light to dissipate heat allows for higher power, and thus brighter, more efficient lights. Thus, ongoing efforts exist to increase the amount of heat dissipated from solid state lights, including those used in applications such as track lights.

### SUMMARY OF THE INVENTION

The invention can be implemented in a number of ways, including as an apparatus, as a device incorporating both heat sink and solid state light source, and as a system.

In one embodiment, a track for a track lighting system comprises an elongated, continuous track configured to support a plurality of solid state light fixtures. The track has at least one recess for supporting the plurality of solid state light fixtures, and a heat sink in thermal communication with the at least one recess, the heat sink dissipating heat from the solid state light fixtures.

In another embodiment, a track lighting system comprises an elongated, continuous track comprising at least one recess, at least one solid state light fixture affixed to the at least one recess, and a heat sink affixed to the track and in thermal communication with the at least one solid state light fixture so as to dissipate heat from the at least one solid state light fixture.

In a further embodiment, a track for a track lighting system is configured to support at least one solid state light and comprises a heat sink configured to dissipate heat from the at least one solid state light.

Other aspects and advantages of the invention will become apparent from the following detailed description taken in conjunction with the accompanying drawings which illustrate, by way of example, the principles of the invention.

### BRIEF DESCRIPTION OF THE DRAWINGS

For a better understanding of the invention, reference should be made to the following detailed description taken in conjunction with the accompanying drawings, in which:

FIGS. 1A-1B are front and cutaway side views, respectively, of a track for a track lighting system, illustrating features including a heat sink constructed in accordance with embodiments of the current invention.

FIG. 1C is a further cutaway side view of the track of FIGS. 1A-1B with an affixed solid state light fixture extending outward from the track.

FIGS. 2A-2B are front and cutaway side views, respectively, of a track having recessed solid state lights and a heat sink constructed in accordance with embodiments of the current invention.

FIGS. 3A-3D are cutaway side views of track lighting systems of the current invention, illustrating various heat sinks.

Like reference numerals refer to corresponding parts throughout the drawings.

### DETAILED DESCRIPTION OF EMBODIMENTS OF THE INVENTION

As noted above, ongoing efforts exist to increase the heat dissipation of solid state lights, and in particular of track lighting systems employing solid state lights. However, current efforts often focus on the solid state light itself, typically attempting to increase the amount of heat that the solid state light itself dissipates. In contrast, embodiments of the current invention seek to increase heat dissipation by utilizing a track lighting system with a heat sink, thus accomplishing increased heat dissipation via a separate device, i.e. a heat sinking track, rather than altering the solid state light itself. A second embodiment integrates the solid state light source to the heat sink track itself. In this manner, embodiments of the invention increase the amount of heat dissipated from solid state lights, possibly even without requiring any redesign of the solid state light itself. This has the twin benefits of increasing heat dissipation, thus allowing for increased solid-state-light power, while also shifting the burden of heat dissipation to a separate or integrated device, so that solid state lights can be optimized for better lighting performance, rather than for increased heat dissipation.

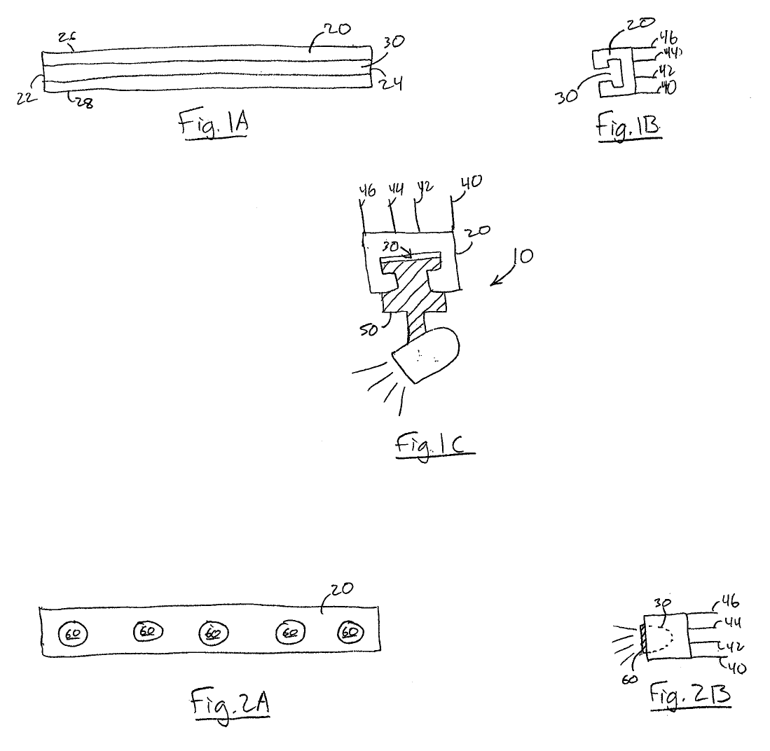

FIGS. 1A-1C illustrate a track lighting system constructed in accordance with the present invention. Track lighting system 10 includes a track 20 that is an elongated member with left and right ends 22, 24, first and second sides 26, 28, and a recess 30 for supporting one or more light fixtures 50. The track 20 can be made of any thermally conductive material or materials (examples are metals such as steel or aluminum, thermally conductive plastics or ceramics, or the like) that make it capable of transferring heat to a heat sink. In this embodiment, the heat sink is constructed with heat sink fins 40-46. As is known to those of skill in the art, the recess 30 receives one or more light fixtures 50, each of which generally extend from the track 20 and contain within them a solid state light such as an LED light. Those of skill in the art also understand that both the fixtures 50 and the recess 30 are provided with electrical contacts (not shown for purposes of clarity) for placing the LED light in electrical communication with a source of electrical power. This allows users to position the light fixtures 50 along the recess 30 of the track 20 so that the contacts of the fixtures 50 and recess 30 are placed in electrical communication with each other, thus providing electrical power to the solid state light.

In the operation of this embodiment, the light fixtures 50, recess 30, and track 20 are configured (in any known fashion) so that the fins 40-46 are in thermal communication with the solid state light of the light fixtures 50. In this manner, fins 40-46 sink heat generated by operation of the solid state lights. Furthermore, fins 40-46 provide added surface area available for convective heat transfer. Thus, heat from the solid state lights is transferred to the fins 40-46, heating the fins 40-46. Convective air currents flowing across the surfaces of the fins 40-46 cool them, increasing the amount of heat dissipated from the solid state lights. Thus, the addition of heat sink fins 40-46 allows for more heat to be dissipated from the solid state lights, in turn allowing for brighter and more efficient solid-state-lights.

The track 20 can utilize any structures or methods for transferring heat from the lights. These include but are not limited to transmission via mechanical means, thermal heat pipes and associated internal liquids and/or gases, and active cooling, such as fans or piezo-electric devices forcing air to and or through the fins.

One of ordinary skill in the art will realize that the track lighting system 10 can be attached to structures, e.g. walls or ceilings, in any manner. For example, the ends 22-24 or sides 26-28 can be attached to walls or ceilings by flanges (not shown) containing screw holes or adhesive strips, so long as the flanges are not sized to significantly interrupt the flow of air or other cooling medium across the fins 40-46. The invention contemplates any known method or device by which track lighting system 10 can be attached to a structure without significant disruption of air flow across fins 40-46. One of ordinary skill in the art will also realize that the solid state lights can be any solid state light, such as an LED light.

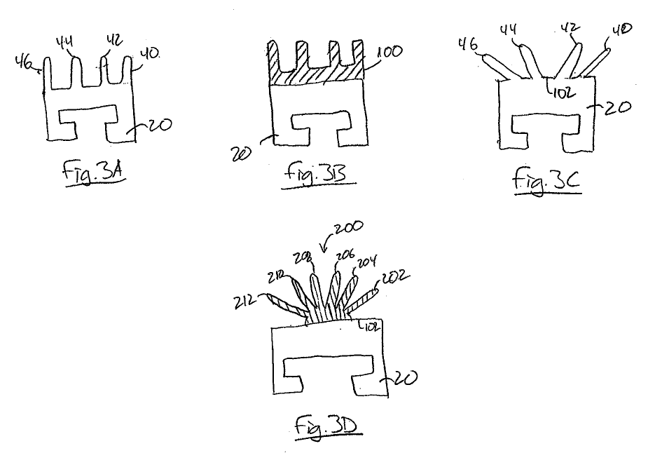

FIGS. 2A-2B illustrate a further embodiment of the invention. Here, the light fixtures 50 are not present. Instead, the recesses 30 are recessed into the body of the track 20 itself, and are configured to receive a solid state bulb or light source 60. In this manner, each solid state light source 60 does not protrude significantly from the body of the track 20, but rather is recessed into the track 20, although the invention also covers embodiments in which solid state light sources 60 do protrude from the track 20. The embodiment can include all optical enhancements that may placed over the solid-state-light source, such as a lens or reflector, to control or re-direct the light from the solid-state light source.

In both the embodiment of FIGS. 1A-1C and the embodiment of FIGS. 2A-2B, the track 20 can include a driver (not shown) within, for converting electrical power to levels appropriate for a solid state light. Alternatively, the driver can be located within each fixture 50, or remote from the track 20 altogether. The driver can be any device or circuitry for converting electrical power to appropriate levels. Similarly, the recesses 30 of FIGS. 2A-2B and the fixtures 50 of FIGS. 1A-1C can each be configured to accept any standard track lighting connector or solid state bulb. For instance, they can each be configured with a socket sized to accept any standard Edison screw base. In particular, it is contemplated that recesses 30 and/or fixtures 50 employed in the United States can be configured to accept any one or more of E5, E10, E11, E12, E17, E26, E26D, E29, and E39 screw bases, BA15S and BA15D bayonet bases, and G4 and GY6.35 bi-pin bases, while those employed in other locations, including Europe, can be configured to accept any one or more of E10, E11, E14, E27, and E40 screw bases, BA15S and BA15D bayonet bases, and G4 and GY6.35 bi-pin bases.

The invention contemplates any heat sink design capable of dissipating heat from a solid state light and suitable for use with a track lighting system. FIGS. 3A-3D are cutaway side views of track lighting systems of the current invention, illustrating various such heat sinks. FIG. 3A illustrates a heat sink having fins 40-46 that are integrally formed with the track 20, such as by forming the track 20 and fins 40-46 from a single mold, or machining them from a single piece of material. In contrast, FIG. 3B illustrates a heat sink 100 that is fabricated separately from track 20, and later joined thereto. Separate heat sinks 100 and tracks 20 are often more easily and cheaply fabricated than the integral heat sink/track design of FIG. 3A. The heat sink 100 can be joined to the track 20 in any manner that allows for effective thermal communication between the two parts. For example, metal screws or a thermally conductive glue can be used to bond the two parts.

FIGS. 3C-3D highlight the fact that the invention contemplates not only fins 40-46 that extend perpendicularly from the track 20, but also fins 40-46 that extend at one or more angles there from. For example, FIG. 3C illustrates fins 40-46 that are integrally formed with the track 20, but generally extend at an angle relative to the surface 102 of the track 20. Fins extending at any angle(s) are contemplated. Similarly, FIG. 3D illustrates a heat sink 200 that is fabricated as a separate structure from track 20, and has fins 202-212 that extend at angles relative to surface 102.

The foregoing description, for purposes of explanation, used specific nomenclature to provide a thorough understanding of the invention. However, it will be apparent to one skilled in the art that the specific details are not required in order to practice the invention. In other instances, well known devices are shown in block form in order to avoid unnecessary distraction from the underlying invention. Thus, the foregoing descriptions of specific embodiments of the present invention are presented for purposes of illustration and description. They are not intended to be exhaustive or to limit the invention to the precise forms disclosed. Rather, many modifications and variations are possible in view of the above teachings. For example, the invention contemplates heat sinks adapted for connection to and/or use with any suitable track lighting system, and any solid state light. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

What is claimed is:

1. A track for a track lighting system, comprising:
an elongated, continuous track configured to support a plurality of solid state light fixtures, the track comprising:
at least one recess for supporting the plurality of solid state light fixtures; and
a heat sink in thermal communication with the at least one recess, the heat sink dissipating heat from the solid state light fixtures.

2. The track of claim 1, wherein:
the track has a first side and an opposite second side;
the at least one recess is located proximate to the first side; and
the heat sink extends from the second side.

3. The track of claim 2, wherein the heat sink further includes a plurality of fins in thermal communication with the at least one recess and extending from the second side, the fins dissipating heat from the at least one recess.

4. The track of claim 3, wherein each fin of the plurality of fins is oriented generally perpendicular to the second side.

5. The track of claim 3, wherein each fin of the plurality of fins is oriented at one or more angles relative to the second side.

6. The track of claim 2, wherein the recess supports solid state light fixtures extending from the first side.

7. The track of claim 2, wherein the recess supports solid state light fixtures recessed into the track.

8. The track of claim 2, wherein the recess is configured to receive a solid state light.

9. The track of claim 1, wherein the solid state light fixtures are LED light fixtures.

10. A track lighting system, comprising:
an elongated, continuous track comprising at least one recess;
at least one solid state light fixture affixed to the at least one recess; and
a heat sink affixed to the track and in thermal communication with the at least one solid state light fixture so as to dissipate heat from the at least one solid state light fixture.

11. The track lighting system of claim 10, wherein:
the track has a first side and an opposite second side;
the at least one recess is located proximate to the first side; and
the heat sink extends from the second side.

12. The track lighting system of claim 11, wherein the heat sink further includes a plurality of fins in thermal communication with the at least one solid state light fixture and extending from the second side, the fins dissipating heat from the at least one solid state light fixture.

13. The track lighting system of claim 12, wherein each fin of the plurality of fins is oriented generally perpendicular to the second side.

14. The track lighting system of claim 12, wherein each fin of the plurality of fins is oriented at one or more angles relative to the second side.

15. The track lighting system of claim 11, wherein the at least one solid state light fixture extends from the first side.

16. The track lighting system of claim 11, wherein the at least one solid state light fixture is at least partially recessed into the track.

17. The track lighting system of claim 10, wherein the solid state light fixtures are LED light fixtures.

18. A track for a track lighting system, the track being configured to support at least one solid state light and comprising a heat sink configured to dissipate heat from the at least one solid state light.
